(19) United States
(12) Patent Application Publication
(10) Pub. No.: US 2012/0247141 A1
(43) Pub. Date: Oct. 4, 2012

(54) Reciprocating Refrigeration Compressor Oil Sealing

(75) Inventors: Alexander Lifson, Manlius, NY (US); John Mulcahy, Liverpool, NY (US)

(73) Assignee: CARRIER CORPORATION, Farmington, CT (US)

(21) Appl. No.: 13/515,371

(22) PCT Filed: Nov. 24, 2010
(86) PCT No.: PCT/US10/57992

§ 371 Date: Jun. 12, 2012

Related U.S. Application Data
(60) Provisional application No. 61/295,009, filed on Jan. 14, 2010.

(51) Int. Cl. B60H 1/32; F04B 53/00; F04B 19/22

(52) U.S. Cl. 62/243; 417/437

(57) ABSTRACT

A compressor (20) has a case (22) and a crankshaft (38). The case has at least one cylinder (30 32). For each of the cylinders, the compressor includes a piston (34) mounted for reciprocal movement at least partially within the cylinder. A connecting rod (36) couples each piston to the crankshaft. The case has a wall through which the crankshaft extends. The case bears a lip seal as a primary seal (97). The lip seal engages an adjacent portion (86) of the crankshaft. The adjacent portion bears a coating (140).

### CROSS-REFERENCE TO RELATED APPLICATION

Benefit is claimed of U.S. Patent Application Ser. No. 61/295,009, filed Jan. 14, 2010, and entitled “Reciprocating Refrigeration Compressor Oil Sealing”, the disclosure of which is incorporated by reference herein in its entirety as if set forth at length.

### BACKGROUND

The present disclosure relates to refrigeration compressors. More particularly, it relates to compressor shaft sealing.

A variety of refrigerant compressor configurations are in common use. Among these configurations are: screw compressors; scroll compressors; and reciprocating piston compressors. One particular type of refrigeration system is the transport refrigeration system (e.g., truck, trailer, and cargo container refrigeration systems). An exemplary state of the art transport refrigeration system uses an internal combustion engine to directly or indirectly drive a reciprocating piston compressor. One current transport refrigeration system uses a diesel engine driven to power a reciprocating piston compressor which uses R-404A HFC refrigerant. Refrigerant compressors can also be used to refrigerate goods in a fixed site (e.g., supermarket) application as well as, for example, for air conditioning (e.g., cooling and/or heating applications) of commercial buildings and residential buildings.

More recently, it has been proposed to use carbon dioxide-based refrigerants (e.g., R-744) for transport applications due to concerns regarding the environmental impact of HFCs. In addition to refrigerants mentioned above, other refrigerants can be used in conjunction with refrigerant compressors of that type, including, but not limited to R-22, R410A, R134a, R410a.

In hermetic or semi-hermetic compressors, an electric motor is contained within the compressor's case. In such compressors, the crankshaft is fully internal to the case and does not need to be sealed relative to the case. In other (open-drive) compressors, the motor or engine drive is external to the case and the crankshaft penetrates the case. An external portion of the crankshaft is mechanically coupled to the motor or engine. In such situations, a portion of the crankshaft penetrates the case and must be sealed to prevent refrigerant leakage. One proposed sealing system is disclosed in US2004/0113369 of Wright et al.

### SUMMARY

One aspect of the disclosure involves a compressor having a case and a crankshaft. The case has an inlet, at least one cylinder, an outlet, and a crankcase compartment. For each of the cylinders, the compressor includes a piston mounted for reciprocal movement at least partially within the cylinder. A connecting rod couples each piston to the crankshaft. The case has a wall through which the crankshaft extends. The case bears a lip seal as a primary seal. The lip seal engages an adjacent portion of the crankshaft. The adjacent portion bears a coating.

In various implementations, the compressor may further include one or more bearings mounted within the wall and supporting the crankshaft. The case may comprise a gland plate. The lip seal may be mounted in the gland plate. A bearing may be mounted within the wall adjacent the gland plate and supporting the crankshaft.

Other aspects of the disclosure involve a refrigeration or air conditioning system including such a compressor. The system may include a recirculating flowpath through the compressor. A first heat exchanger may be positioned along the flowpath downstream of the compressor. An expansion device may be positioned along the flowpath downstream of the first heat exchanger. A second heat exchanger may be positioned along the flowpath downstream of the expansion device. The refrigerant charge may comprise R-404A. The system may be a refrigerated transport system. The refrigerated transport system may further comprise a container. The second heat exchanger may be positioned to cool an interior of the container. The system may be a fixed site refrigeration or air conditioning system. The fixed refrigeration system may further comprise multiple refrigerated or air conditioned spaces. There may be a plurality of said second heat exchangers, each being positioned to cool an associated such refrigerated or air conditioned space.

Other aspects of the disclosure involve methods of use.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a vertical longitudinal sectional view of a compressor.

FIG. 2 is an enlarged view of a seal compartment of the compressor of FIG. 1.

FIG. 3 is a schematic view of a refrigeration system.

FIG. 4 is a partially schematic view of a tractor trailer combination including the system of FIG. 3.

FIG. 5 is a schematic view of a fixed-location system.

Like reference numbers and designations in the various drawings indicate like elements.

### DETAILED DESCRIPTION

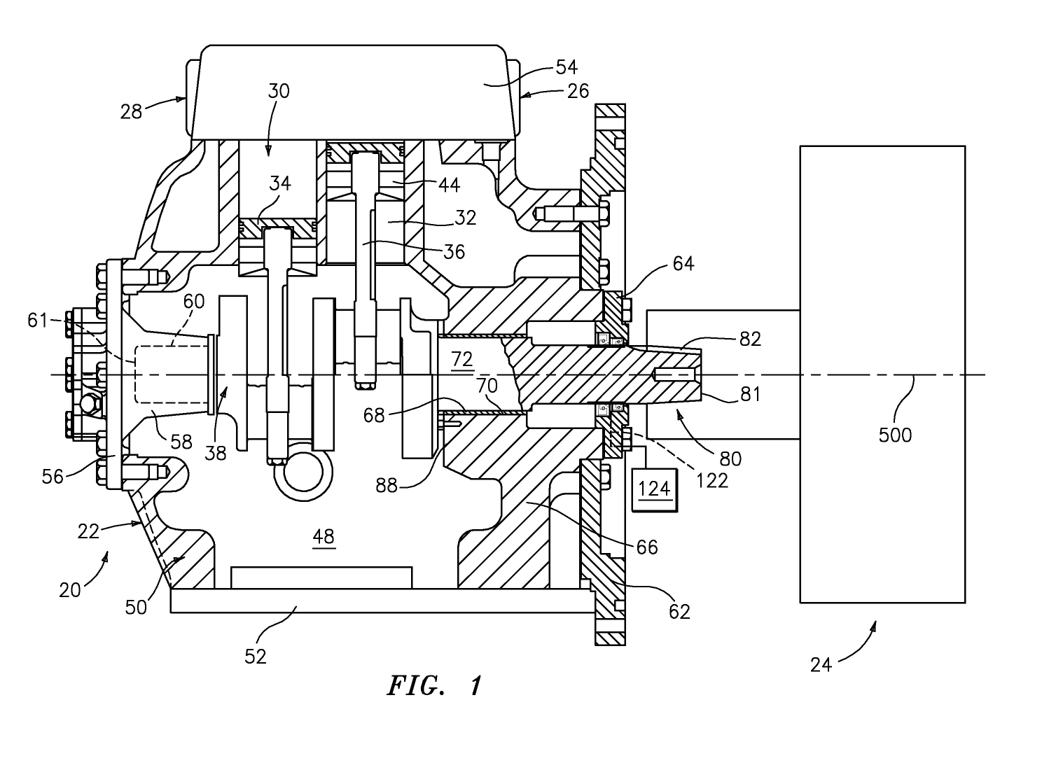

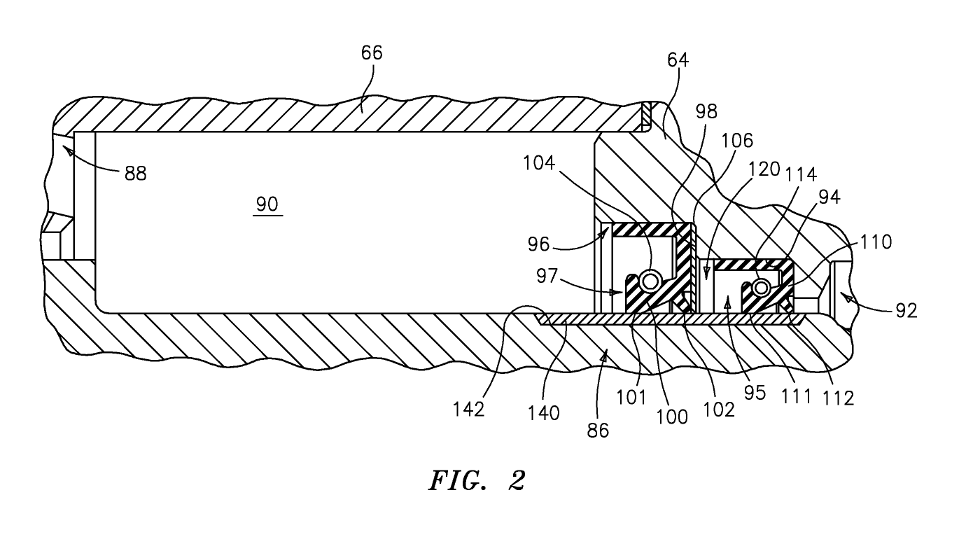

FIGS. 1 and 2 show an exemplary compressor 20. The compressor 20 has a housing (case) assembly 22. The exemplary compressor is driven by an engine 24 (schematically shown). The exemplary case 22 has a suction port (inlet) 26 and a discharge port (outlet) 28. The housing defines a plurality of cylinders 30 and 32. Each cylinder accommodates an associated piston 34 mounted for reciprocal movement at least partially within the cylinder. Exemplary multi-cylinder configurations include: in-line; V (vee); and horizontally opposed. The exemplary compressor is based upon the well known Model 05G compressor manufactured by Carrier Corporation, Syracuse, N.Y.

Each of the cylinders includes a suction location and a discharge location. For example, the cylinders may be coupled in parallel so that the suction location is shared/common suction plenum fed by the suction port 26 and the discharge location is a shared/common discharge plenum feeding the discharge port 28. In other configurations, the cylinders may share suction locations/conditions but have different discharge locations/conditions. In other configurations, the cylinders may be in series. Exemplary refrigerant is R-404A.

Each of the pistons 34 is coupled via an associated connecting rod 36 to a crankshaft 38. The exemplary crankshaft 38 is held within the case by bearings for rotation about an axis 500. Each piston 30, 32 is coupled to its associated connecting rod 36 via an associated wrist pin 44. The exemplary case includes a main member 50 (e.g., casting of a housing) which forms a cylinder block. A lower end of the main member is closed by a sump plate/cover 52. One or more heads 54 may cover the cylinders. At a front end (e.g., a “distal” end meaning away from the engine), a bearing body 56 (optimally integrated with an oil pump or other system) closes the case and bears a bearing 58 which engages a forward end portion 60 (schematically shown) of the crankshaft near a forward end 61 of the crankshaft. A rear end of the case is closed by a flange 62 and gland plate 64 mounted to the main member 50. The flange 62 and gland plate 64 are mounted along a rear wall 66 of the main member which bears/carries a bearing 68 in a bore/compartment 70. The bearing 68 engages a first intermediate portion 72 of the crankshaft. A rear/second end portion 80 of the crankshaft (near the second end 81 of the crankshaft) is external to the case. The second end portion 80 may bear features (e.g., splines or a keyway 82) for coupling to the engine (including any intervening structure). FIG. 2 shows a second intermediate portion 86 of the crankshaft between the end portion 80 and the first intermediate portion 72.

Where the crankshaft penetrates the case, the crankshaft must be sealed relative to the case. An exemplary sealing system is shown as a modification of the compressor of US2004/0113369 of Wright et al. In Wright et al., the rear/proximal end wall of the case is formed by the rear wall 66 of the main member, and the flange/gland plate combination. An inboard portion 88 of the rear wall 66 defines the bearing compartment 70. Extending outboard (axially) of the bearing compartment 70, the rear wall 66 surrounds most of a seal compartment 90 in which the Wright et al. primary seal would be mounted. The gland plate 64 covers the end of the seal compartment 90 and has an aperture 92 through which the crankshaft extends. Inboard (axially) of the aperture 92, the gland plate has an annular compartment 94 into which a secondary seal 95 is mounted. The exemplary secondary seal 95 may be a lip seal as in Wright et al. The exemplary gland plate has a primary seal compartment 96 inboard of the secondary seal compartment 94 and containing a primary seal 97. The primary seal is “primary” in that it is exposed to the internal compressor pressure at the outboard end of the bearing. The pressure difference (delta P) across the primary seal would be a majority of the pressure difference between sump and atmosphere (e.g., 50-100% of such difference or, more narrowly, 90-100%). If the secondary seal compartment is exposed to the ambient environment-as for example if the leaked oil is allowed to be collected into oil retention container, then the pressure in the secondary seal compartment would essentially be equal to the atmospheric pressure and the primary seal would see essentially 100% of the difference in pressure. The secondary seal is “secondary” in that it is a back-up and intervenes between the primary seal and the external environment. The designation of a seal as “primary” does not require that there be a secondary seal. The exemplary primary seal compartment and secondary seal compartment form a larger stepped compartment with a step or shoulder 98 separating the two. The primary seal 97 is also a lip seal and may be press fit its compartment 96.

The exemplary primary seal 97 comprises a generally annular resilient sealing member 100 having a pair of annular lips 101, 102 for sealing with an adjacent portion of the crankshaft. The annular lip 101 would normally function to seal the pressure differential and the annular lip 102 (sometimes called a dust lip) would normally function to protect the lip 101 from any foreign particles coming in contact with lip 101. The lip 101 may consist of a series of annlar lips similar in design to a singular annular lip 101. The exemplary primary seal 97 may have a radial spring 104 (e.g., a steel coil) to bias the seal (namely the lips) radially inward. The exemplary primary seal 97 includes an optional end plate or support washer 106 which longitudinally supports the primary seal between the primary and secondary seals so as to resist blowout from high internal pressures which reach the seal compartment 90 inboard of the primary seal. The primary seal 97 may also have a rigid (e.g., metallic) core (not shown) to provide rigidity and help allow it to be press fit in its compartment.

The exemplary secondary seal may also have a resilient member 110 having a pair of lips 111, 112 and a radial spring 114. The exemplary secondary seal will not be expected to experience the pressure differences of the primary seal. The main purpose of the secondary seal is to prevent the contamination of the primary seal by foreign objects from the outside environment (e.g., dust particles). A space 120 between the primary and secondary seals can trap small amounts of oil that leak through the primary seal. An optional collection passageway 122 (schematically shown) may communicate with the space 120 to pass such oil to an optional oil collection bottle 124. The passageway 122 and collection bottle 124 prevent oil migration over the secondary lip seal to the outside environment.

The high pressures associated with the pressure difference across the primary lip seal can lead to increased contact forces between the seal lip and the crankshaft. With a ductile iron crankshaft being in direct contact with the lip seal, the iron microstructure is such that ferrite caps in the surface of the shaft may separate, leading to seal wear and leakage. Accordingly, along at least a portion of the crankshaft engaging the primary seal, the shaft bears a smooth hard coating 140 selected to not abrade the resilient members and to maintain its own smoothness (surface finish) so as to maintain good sealing and prevent wear. The coating 140 may extend over an exemplary continuous region including a portion of the crankshaft engaged by the secondary seal.

The exemplary coating may be applied to the shaft by first preparing the shaft. Exemplary preparation may include grinding an undercut 142 along the shaft portion 86 to receive the coating. An exemplary undercut may form a radially outwardly-open annular channel having a cylindrical base and first and second radially-extending end walls. For example, when reengineering or remanufacturing a baseline shaft, the undercut may be sufficient so that the coating restores the ultimate shaft outer diameter (OD). In an exemplary remanufacturing, after the compressor has been operated for some length of time, the coating may be re-polished to its original surface finish specification. If substantial abrasion of the coating took place during the operation, the coating may be added to the already existing coating or the existing coating may be stripped all together and new coating re-introduced (deposited) in place of the old coating. The adjacent portions of the shaft may be masked to prevent coating deposition thereon. The coating may be applied via an in situ buildup process such as plasma spray. Exemplary build-up is to a characteristic thickness (e.g., an average thickness or at least a thickness at/adjacent the lips) of 25-3000 micrometer, more narrowly, 300-1000 micrometer. Exemplary coatings include chrome oxide, alumina-titania, tungsten carbide-based coatings, chrome, and chrome carbide nichrome coatings. After an initial application, the coating may be machined/polished to achieve appropriate surface finish characteristics. Exemplary surface finish properties are in the range of: Ra 20 μin; Rz 25-150 μin; Rpm 10-80 μin. Typically the coating also needs to satisfy certain hardness requirements. Exemplary hardness properties are Rockwell C 55 or greater (e.g., 55-70, more narrowly 60-65).

Relative to more complex sealing systems, the use of a primary lip seal 97 may reduce manufacturing costs. When combined with the hard coating 140, it may further improve overall reliability. In a service situation, the flange 62 and gland plate 64 may be removed and one or both lip seals extracted and replaced with new lip seals. Repair of the coating 140 may be optional, depending upon the particular service interval and the existence of actual wear. If work is done on the coating 140, this might vary from merely polishing the coating to coating removal and recoating. By building up the coating 140 on the shaft, greater sealing integrity may be achieved than with a pre-formed hard sleeve. For example, there may be a tendency for refrigerant to leak through the interface between a pre-formed sleeve and the shaft substrate.

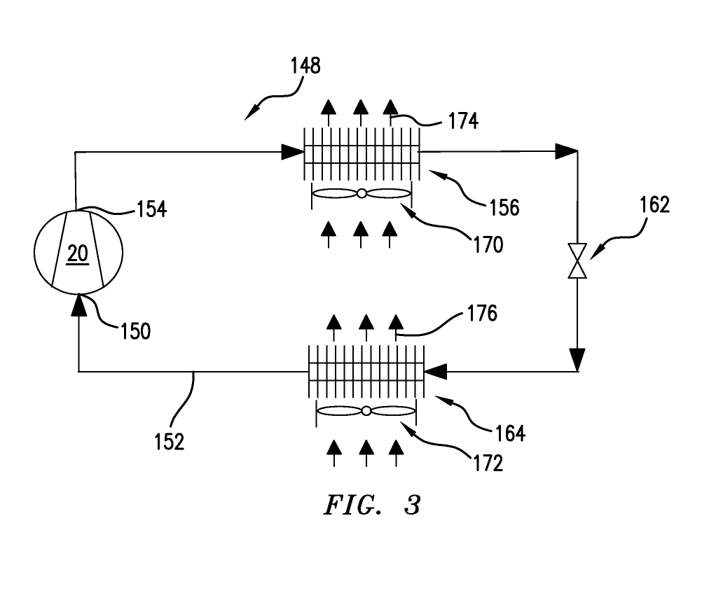

FIG. 3 shows an exemplary refrigeration system 148 including the compressor 20. The system 148 includes a system suction location/condition 150 at the suction port 26. A refrigerant primary flowpath 152 proceeds downstream from the suction location/condition 150 through the compressor cylinders to be discharged from a discharge location/condition 154 at the discharge port 28. The primary flowpath 152 proceeds downstream through the inlet of a first heat exchanger (gas cooler/condenser) 156 to exit the outlet of the gas cooler/condenser. The primary flowpath 152 then proceeds downstream through an expansion device 162. The primary flowpath 152 then proceeds downstream through a second heat exchanger (evaporator) 164 to return to the suction condition/location 150.

In a normal operating condition, a recirculating flow of refrigerant passes along the primary flowpath 52, being compressed in the cylinders. The compressed refrigerant is cooled in the gas cooler/condenser 156, expanded in the expansion device 162, and then heated in the evaporator 164. In an exemplary implementation, the gas cooler/condenser 156 and evaporator 164 are refrigerant-air heat exchangers with associated fan (170; 172)-forced airflows (174; 176). The gas cooler/condenser 156 can be cooled by circulating liquid (e.g., water) pumped over the gas cooler/condenser coils. The evaporator 164 is normally located in the refrigerated space. Similarly, the gas cooler/condenser 156 or its airflow may be external to the refrigerated space.

Additional system components and further system variations are possible (e.g., multi-zone/evaporator configurations, economized configurations, and the like). Exemplary systems include refrigerated transport units and fixed commercial refrigeration systems.

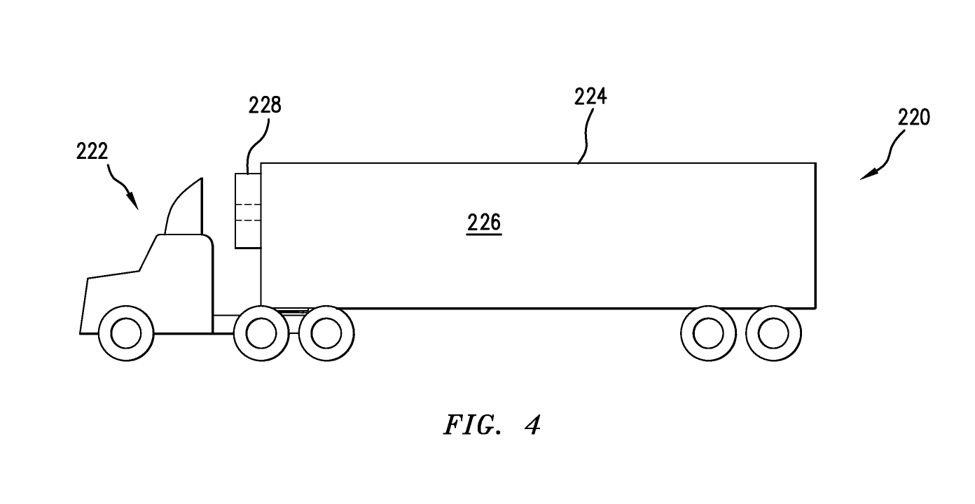

FIG. 4 shows a refrigerated transport unit (system) 220 in the form of a refrigerated trailer. The trailer may be pulled by a tractor 222. The exemplary trailer includes a container/box 224 defining an interior/compartment 226 (the refrigerated space). An equipment housing 228 mounted to a front of the box 224 may contain the engine (e.g., diesel), the compressor, and the gas cooler/condenser. The evaporator and its associated fan may be positioned in or otherwise in thermal communication with the compartment 226.

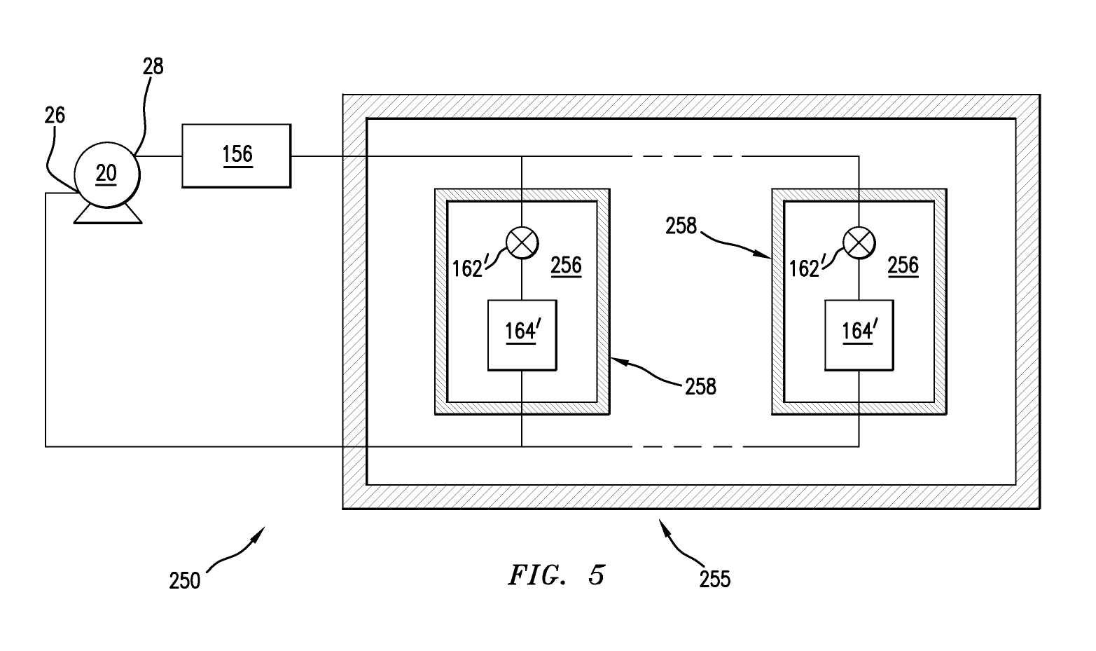

An exemplary fixed commercial air conditioning system 250 (FIG. 5) includes one or more central compressors 20 and heat rejection heat exchangers 156, for example located outside or on the roof of the building 255 commonly serving multiple air conditioned spaces 256 (e.g., such as for example rooms 258 in the building). Each such space may have its own heat absorption heat exchanger 164′ and expansion device 162′ (or there may be a common expansion device).

The compressor may be manufactured via otherwise conventional manufacturing techniques.

Although an embodiment is described above in detail, such description is not intended for limiting the scope of the present disclosure. It will be understood that various modifications may be made without departing from the spirit and scope of the disclosure. For example, when implemented in the reengineering of an existing compressor configuration, details of the existing configuration may influence or dictate details of any particular implementation. Accordingly, other embodiments are within the scope of the following claims.

1. A compressor (20) comprising:
a case (22) having:
an inlet;
at least one cylinder (30-32);
a crankcase compartment (48); and
an outlet;
a crankshaft (38), the case having a wall through which the crankshaft extends;
for each of said cylinders:
a piston (34) mounted for reciprocal movement at least partially within the cylinder;
a connecting rod (36) coupling the piston to the crankshaft; and
a wrist pin (44) coupling the connecting rod to the piston;
wherein:
the case bears a primary seal (97), the primary seal being a lip seal engaging an adjacent portion (86) of the crankshaft; and
the adjacent portion bears a coating (140).

2. The compressor of claim 1 wherein:
the case comprises a gland plate (64); and
the lip seal (97) is mounted in the gland plate.

3. The compressor of claim 2 further comprising:
a bearing (68) mounted within a wall (66) adjacent the gland plate and supporting the crankshaft.

4. The compressor of claim 2 wherein:
the lip seal is press-fit into the gland plate.

5. The compressor of claim 1 further comprising:
a secondary lip seal (95).

6. The compressor of claim 1 wherein:
the lip seal is exposed to a crankcase pressure.

7. The compressor of claim 1 wherein:
the coating comprises chrome oxide.

8. The compressor of claim 1 wherein:
the coating has a characteristic thickness of 0.3-1.0 mm at a contact location with the lip seal.

9. The compressor of claim 1 wherein:
the coating comprises at least one of:
alumina-titania; tungsten carbide-based coating; chrome; chrome carbide nichrome.

10. The compressor of claim 9 wherein:
the adjacent portion of the shaft comprises ductile iron.

11. The compressor of claim 1 wherein:
the lip seal has a radial spring (104).

12. A system (48; 250) comprising:
the compressor (20) of claim 1;
an internal combustion engine mechanically coupled to the crankshaft;
a refrigerant recirculating flowpath (152) through the compressor;
a first heat exchanger (156) along the flowpath downstream of the compressor;
an expansion device (162; 162′) along the flowpath downstream of the first heat exchanger; and
a second heat exchanger (164; 164′) along the flowpath downstream of the expansion device.

13. The system of claim 12 wherein:
a refrigerant charge comprises R-404A.

14. The system of claim 12 being a refrigerated transport system further comprising:
a container (224), the second heat exchanger being positioned to cool an interior (226) of the container.

15. The system of claim 12 being a fixed refrigeration system further comprising:
multiple refrigerated or air conditioned spaces (256); and
a plurality of said second heat exchangers (164′), each being positioned to cool an associated said refrigerated or air conditioned space.

16. The compressor of claim 1 wherein:
a pressure difference across the primary seal is a majority of a pressure difference between the crankcase compartment and atmosphere; and
the coating is a hard coating.
